(19) United States
(12) Patent Application Publication
(10) Pub. No.: US 2024/0149986 A1
(43) Pub. Date: May 9, 2024

(54) Method for Transshipment of Liquid Cargo on Typical Tankers and Flexible Insert "Removable Coating Tankerpack"

(71) Applicant: Sergey Aleksandrovich NIKOLAENKOV, Saint-Petersburg (RU)

(72) Inventor: Sergey Aleksandrovich NIKOLAENKOV, Saint-Petersburg (RU)

(21) Appl. No.: 18/281,441

(22) PCT Filed: Jan. 24, 2022
(86) PCT No.: PCT/RU2022/050021

§ 371 Date: Sep. 11, 2023

(30) Foreign Application Priority Data
May 17, 2021 (RU) 2021113868

(51) Int. Cl. B63B 25/12; B63B 27/24; B63J 2/14; B67D 9/00

(52) U.S. Cl. CPC B63B 25/12; B63B 27/24; B63J 2/14; B67D 9/00

(57) ABSTRACT

A method of transshipping liquid cargo in a tanker, including loading and unloading. Before loading, inserts are arranged in cargo tanks, with inlet and outlet openings of the inserts attached at corresponding openings of hatches, after which the inserts are unfolded. A temporary cargo system is assembled, including a pipeline with adapters and portable hoses, which are lowered into the openings of the inserts. The cargo is loaded into the tanks at a port of origin through the hatches into the inserts. After loading, the cargo system is disassembled. For unloading, the cargo system is assembled, with submersible pumps attached to ends of the hoses, the hoses with the pumps are lowered into the inserts, and the cargo is unloaded from the tanks to reservoirs at a port of destination using the pumps. The cargo system is disassembled and the inserts are removed from the tanks and sent for disposal.

### CROSS-REFERENCE TO RELATED APPLICATIONS

The present application is the U.S. National Phase of PCT/RU2022/050021, filed on 24 Jan. 2022, which claims priority to Russian Patent Application No. 2021113868, filed on 17 May 2021, the entire contents of which are incorporated herein by reference.

### BACKGROUND

### Technical Field

The invention relates to methods and devices for transshipment of liquid cargo in typical tankers, such as product and chemical carriers.

### Background Art

Cargos carried by the same typical tanker can be either of a single type, for example, only edible oils, or of different types, for example, a tanker can sequentially carry mineral oil, then alcohol, and then edible oil.

If it is necessary to sequentially transport different types of cargo, in accordance with requirements of a shipper, manufacturer, or internal rules of a shipping company, as well as in accordance with the “FOSFA Qualification Requirements and Technical Operation Procedures for ships transporting liquid cargos of edible and technical oils and fats”, cargo tanks and onboard cargo system of a tanker should first be cleaned from remnants of previous cargo before loading a new cargo.

For this purpose, after unloading a cargo at a port, a tanker is taken to sea where cargo tanks and pipelines of the onboard cargo system are cleaned and washed from cargo remnants using special equipment and typically also chemical agents. This procedure is time consuming (it takes up to three weeks) and very costly (the cost of a complete cleaning of a tanker for a new loading amounts up to $250,000).

For example, for complete cleaning of a tanker with a deadweight of 45-50 thousand tons after transportation of oil and before transportation of alcohol takes at least one week and about $150,000.

As such, during cleaning, in accordance with rules of International Convention for the Prevention of Pollution from Ships, MARPOL 73/78 (the document is published in Russian at: https://mirmarine.net/poleznaya-informatsiya/marpol-73-78/1194-prilozhenie-ii-k-konventsii-marpol-73-78-pravila-predotvrashcheniya-zagryazneniya-vrednymi-zhidkimi-veshchestvami-perevozimymi-nalivom), remnants of cargo and cleaning chemical agents are often disposed of by dumping them overboard the tanker, which causes significant harm to the environment.

Usually, liquid cargo is transshipped by typical tankers—chemical and product carriers—using an onboard cargo system that consists of receiving and unloading pipelines.

The onboard cargo system of modern tankers typically includes a main deck pipeline, which is similar to cargo pipelines in terms of its characteristics, design and location, but, unlike the latter, it does not have a rigid connection with cargo tanks. As such, the main pipeline can also be connected to the cargo tanks using portable hoses connected to its run-outs using valves or clinkets, or the main pipeline can be completely isolated and shut.

Description of the onboard cargo system can be found at http://tanker-man.narod.ru/HTML_Files/Type_of_Manifold_Connections.htm.

RU 2401765, published 20 Oct. 2010, IPC B63B25/12, B63B27/24, B67D9/00, B65G67/60, discloses a structure of a tanker cargo system including cargo tanks, a cargo pump, a pressure pipeline, a suction pipeline connected to a lower part of the cargo tanks via a built-in separation tank having a liquid level adjustment mechanism and a shut-off device, and an air ejector connected to an upper part of the cargo tank.

A main disadvantage of using onboard cargo systems of tankers is that, after unloading a cargo, both cargo tanks and cargo lines of the onboard cargo system remain dirty, due to which, if it is necessary to sequentially transport different types of cargo, preparing (cleaning) the tanker before loading the next cargo is considerably time consuming and financially expensive.

Methods for transshipment of liquid cargo via an onboard cargo system, but using disposable collapsible soft containers (inserts) placed in cargo tanks are also known.

For example, a method for transshipment of liquid cargo using soft containers placed in oil tanker tanks is disclosed in a utility model patent RU 192966 “Oil tanker cargo tank”, published 8 Oct. 2019, IPC B63B25/08, B63B25/12, B63B11/04, B63B57/04, B65D77/06.

The document discloses a structure of an oil tanker cargo tank, which includes a body with a cargo hatch with a cover, in which a soft container (inserts) made of a hydrocarbon and seawater resistant material is installed, a pipe for loading and unloading hydrocarbons connected to a loading and unloading crane, pipes for pumping in and removing ballast water, rigidly connected to the body of the cargo tank, while in the lower part of the soft container there is a loading/unloading valve connected to the pipe for loading and unloading hydrocarbons, which is located outside the soft tank, check valves are installed on the hatch cover for bleeding fuel vapors from the soft container and sucking air into a soft container, connected to the soft container through a corrugated sleeve, and which further includes a device for treating ballast water against invasive species, which is rigidly connected, respectively, to the pipes for pumping in and removing ballast water.

Using soft containers (inserts) placed in cargo tanks after unloading cargo and removing the inserts obviates the need for cleaning the cargo tanks before loading the next cargo, since, once the dirty inserts are removed, the tanks are clean. This significantly saves time for preparing the tanker before the next loading.

However, since openings in the soft containers (inserts) intended for their connection to corresponding openings of the onboard cargo system are made in their lower part, loading and unloading of cargo from tanks is only possible via the onboard cargo system of the tanker. As a result, cargo lines of onboard cargo systems remain dirty after cargo transshipment, i.e., cleaning the onboard cargo system before loading the next cargo is still time consuming and costly.

The common disadvantage among all known methods for transshipment of liquid cargo by tankers consists in significant expenses and loss of time involved in preparing a tanker for the next loading. In addition, since detergents and cargo residues are dumped into the sea, as well as due to additional CO2 emissions into the atmosphere caused by the need for a tanker to go to sea in order to clean the tanks and the onboard cargo systems of tankers, during which a tanker's fuel consumption is up to 30 tons per day, environment pollution occurs.

However, according to “International Code for the Construction and Equipment of Ships Carrying Dangerous Chemicals in Bulk” adopted by the Maritime Safety Committee (Resolution MSC.4 (48)) (the document is published online at: https://docs.cntd.ru/document/499003305), certain types of liquid cargo in accordance with the Summary Table of Minimum Requirements (Chapter 17), line “Measurements (column h)” can also be loaded into open type “0” devices (13.1.1.1). That is, it is allowed to load certain types of cargo, such as, for example, animal fat, latex, or paraffin, into cargo tanks by filling them through their upper cargo hatches. However, this method of cargo loading is rarely used since modern ships, as a rule, use onboard cargo systems.

### SUMMARY

### Technical Problem

Using the claimed invention, problems associated with the waste of time and high costs involved if sequential transshipment of different types of liquid cargo in typical tankers is necessary are solved.

### Solution to Problem

The technical result of the claimed invention consists in increasing cost-effectiveness of transshipment of different types of liquid cargo and a significant reduction of turnaround time of typical tankers. Moreover, using the claimed invention, environment pollution that occurs during washing and preparation of a tanker for loading the next cargo is reduced.

The aforementioned technical result is achieved using a method for transshipment of liquid cargo in typical tankers, including the steps of cargo loading and unloading.

To load a liquid cargo the following operations are performed:
1. Before cargo loading, flexible inserts of a special design are arranged in cargo tanks of a tanker, inlet and outlet openings of which are located in their upper part, and which are attached in the corresponding openings of upper cargo hatches of the cargo tanks, after which the flexible inserts are unfolded in the cargo tanks manually and/or using portable onboard fans;
2. Concurrently, a temporary cargo system is assembled on a deck of the tanker, which includes a main deck pipeline, to which adapters and portable hoses equipped with shut-off valves are connected, whereby the portable hoses are lowered into the openings of the flexible inserts arranged in the cargo tanks;
3. Then cargo is loaded into the cargo tanks using equipment provided at a port, such as using pumps, by filling the cargo into the flexible inserts through the upper cargo hatches of the cargo tanks; and
4. After the cargo loading is finished, the temporary cargo system is disassembled, purged, and its components (portable hoses, shutoff valves, adapters, and portable onboard fans) are placed in designated equipment storage areas, which are normally located onboard the tanker.

When the tanker arrives at a port of destination, the liquid cargo is unloaded, for which the following operations are performed:
1. The temporary cargo system is reassembled, including a main deck pipeline, to which adapters and portable hoses equipped with shut-off valves, and submersible pumps (for example Framo pumps by Norwegian company Frank Mohn), which are attached to the ends of the portable hoses, are connected;
2. Then the portable hoses with attached submersible pumps are lowered into the flexible inserts via the upper cargo hatches of the cargo tanks;
3. Then the liquid cargo is unloaded from the cargo tanks using the submersible pumps to intended containers, such as reservoirs provided at the port; and
4. When the cargo unloading is finished, the temporary cargo system is disassembled, purged, and its components (portable hoses, shutoff valves, adapters, and portable onboard fans) are placed in designated equipment storage areas, which are normally located onboard the tanker, while the flexible inserts are removed from the cargo tanks and sent for disposal at the port of unloading.

The claimed method is implemented using special flexible inserts “Removable coating Tankerpacks”, which are designed for loading and unloading liquid cargo through upper cargo hatches of cargo tanks, and made of a plastic that is suitable for their use with a given type of cargo. For example, for the transportation of edible oil and animal fat, inserts made of polyethylene phthalate are used, which is heat-resistant (this plastic is resistant to cargo temperatures up to +220° C.), wherein when it is heated, only water and carbon dioxide are released, which are safe for humans, and therefore it is approved for the transport and storage of food products. To transport other types of liquid cargo, such as latex or paraffin, other inserts that are resistant to this type of cargo in terms of their chemical and physical characteristics are used.

Structurally, flexible insert “Removable coating Tankerpack” is a product that is tailored from plastic which, when unfolded, has a shape and size that correspond to those of a cargo tank, and which has at least two openings in its upper part, and shape, size, and arrangement of which correspond to the openings of the upper cargo tank hatches of cargo tanks, wherein the openings of the flexible insert are provided with flanges made of the same material as the flexible insert per se, or of a different material, for example, a more durable one.

The flanges can also include openings intended for engaging with pins or other fastening elements provided in the corresponding flanges of the openings of the upper cargo hatch of the cargo tank.

Also, the flexible insert “Removable coating Tankerpack” may be further provided with an integrated cargo heating system, which can be a flexible tube embedded in the insert, such as a plastic one, which can be connected to a ship heat transfer system with a medium such as water vapor or hot mineral oil. Use of the integrated cargo heating system allows to deliver liquid cargo, which would become solid if cooled, such as, for example, paraffin, in liquid form to a port of destination.

The flexible insert “Removable coating Tankerpack” is installed in a cargo tank as follows.
1. The flexible insert “Removable coating Tankerpack” is lowered into the cargo tank in a collapsed form through the main hatch which is intended for maintenance and personnel access;
2. The flexible insert is lifted using ropes attached to the flanges of the flexible insert, and the flanges of the flexible insert are attached to the upper cargo hatches of the cargo tank. In doing this, the openings provided in the flanges are placed on the pins provided in the flanges of the corresponding openings of the upper cargo hatches;
3. Then the flexible insert is unfolded inside the cargo tank manually and/or using portable onboard fans. After that, the flexible insert “Removable coating Tankerpack” is ready for use.

After use, the flexible insert is removed from the cargo tank in a reverse order.

For loading and transshipment of different types of liquid cargo, several sets of the flexible inserts “Removable coating Tankerpack”, made of different types of plastic suitable for use with each given type of cargo, are used. Such sets of the flexible inserts are stored onboard a tanker in specially designated places, or at the ports where these cargos are loaded.

### BRIEF DESCRIPTION OF THE DRAWINGS

The claimed method and structure of special flexible inserts “Removable coating Tankerpack” are explained using figures, wherein:

FIG. 1 shows a scheme of temporary cargo system assembly;

FIG. 2 shows the loading of the flexible insert “Removable coating Tankerpack” into cargo tank through its main hatch;

FIG. 3 shows the lifting of the flanges of the flexible insert using ropes so as to attach the flanges to the corresponding flanges of the openings of the upper cargo hatches of the cargo tank;

FIG. 4 shows the unfolding of the flexible insert inside the cargo tank using portable onboard fans;

FIG. 5 shows the loading of a liquid cargo into the flexible inserts installed in a cargo tank through portable hoses;

FIG. 6 shows the unloading of a liquid cargo using the temporary cargo system through portable hoses with attached submersible pumps; and

FIG. 7 shows the flexible insert equipped with the integrated cargo heating system, which is connected to the onboard heat transfer system.

### DETAILED DESCRIPTION

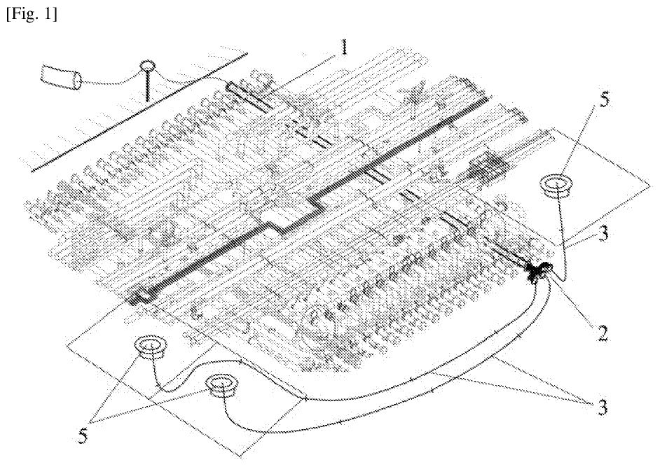

To implement the claimed method for transshipment of liquid cargo in typical tankers in cases when it is allowed to load a cargo into a tanker by filling through the upper cargo hatches of cargo tanks, a temporary cargo system is assembled on the deck of the tanker (FIG. 1), including the main deck pipeline (1), to which one or more adapters (2), as well as portable hoses (3) equipped with shut-off valves are connected.

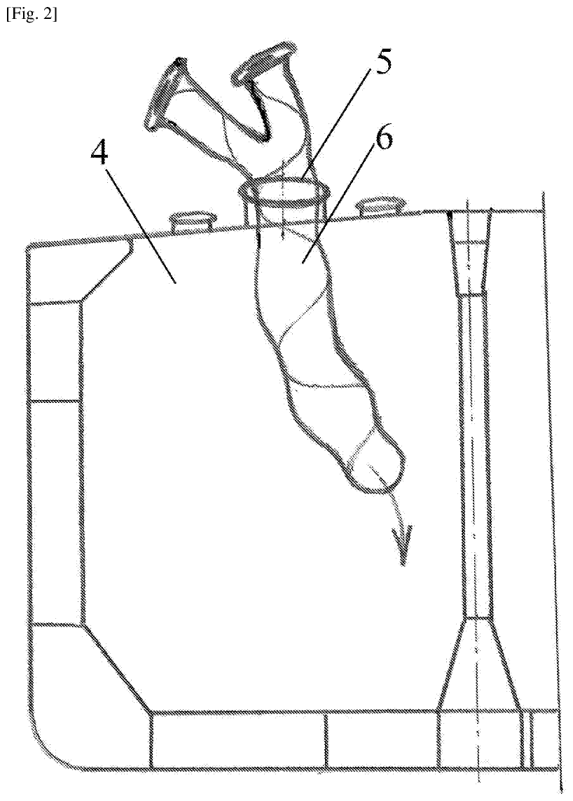

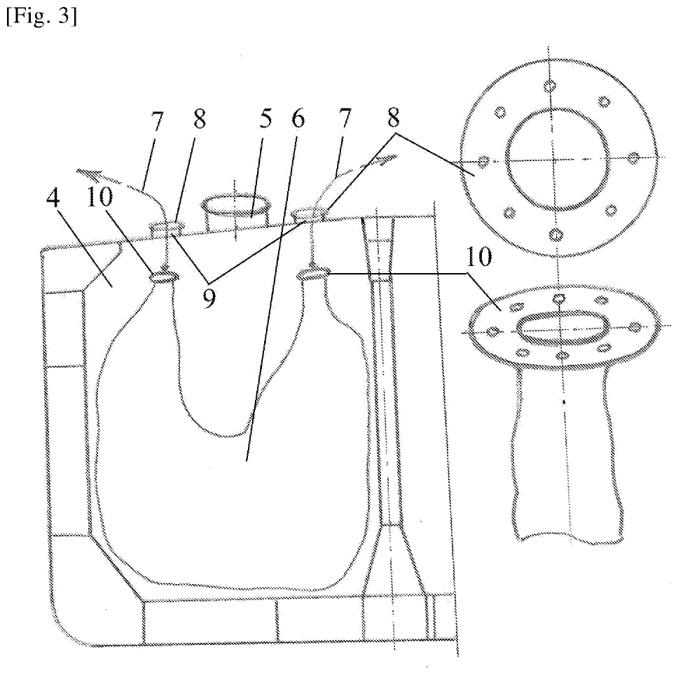

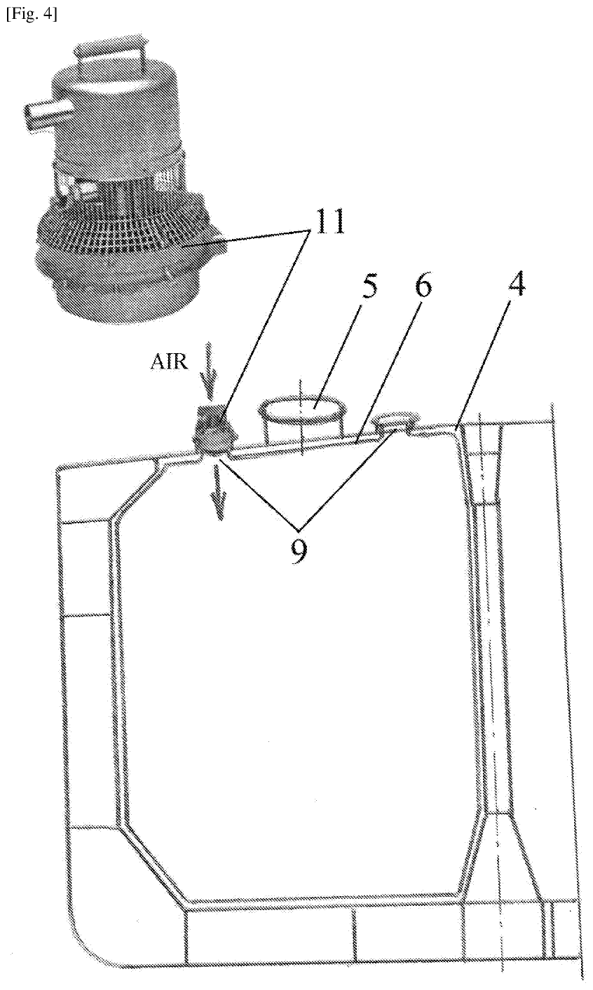

Concurrently, (see FIG. 2), the flexible inserts “Removable coating Tankerpacks” (6) are lowered into the cargo tanks (4) through their main hatches (5), and then (see FIG. 3) the flanges (10) of the flexible inserts (6) are lifted using ropes (7) and attached to the flanges (8) of the openings of the upper cargo hatches (9), after which (see FIG. 4) the flexible inserts (6) are unfolded manually and/or using portable onboard fans (11) until they reach the maximum possible volume of the tanks (4).

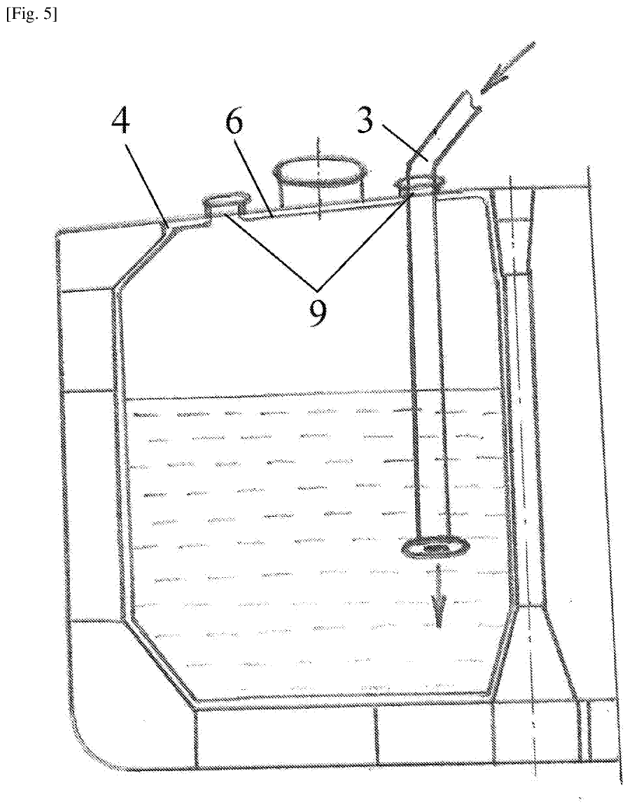

Then the portable hoses (3), through which liquid cargo is loaded, are lowered (see FIG. 5) into the flexible inserts (6).

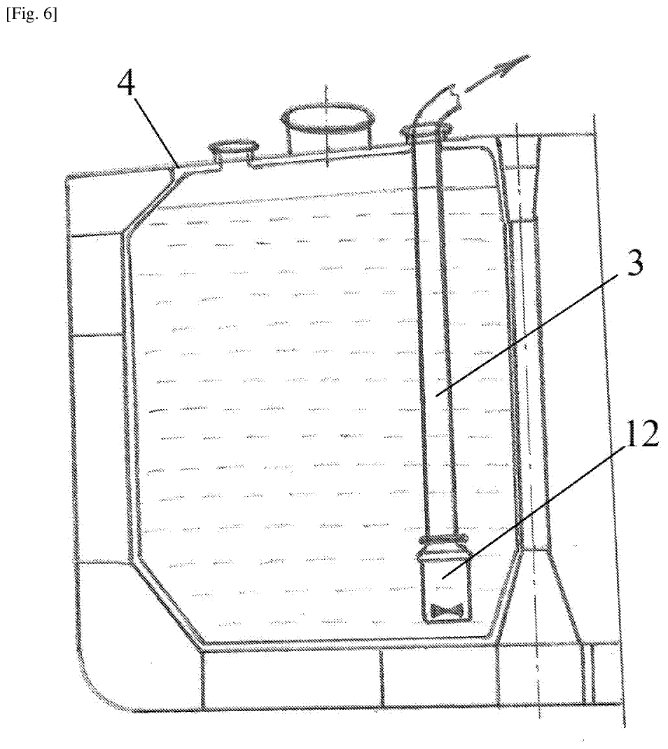

When the cargo is delivered to a destination port (see FIG. 1) the temporary cargo system is reassembled, in particular the main deck pipeline (1) to which adapters (2) and portable hoses (3) equipped with shut-off valves are connected, as well as submersible pumps (12) which are attached to the ends of the portable hoses (3), by which the liquid cargo is unloaded (see FIG. 6).

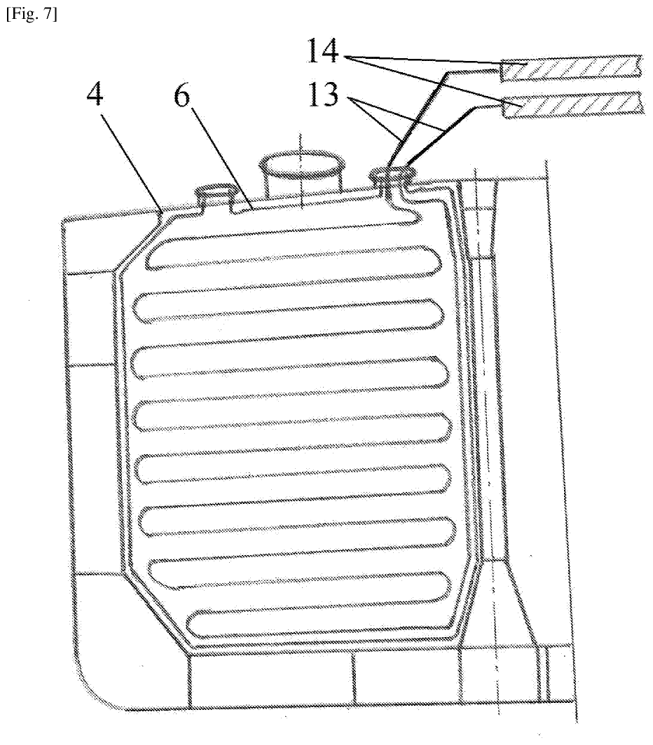

If it is necessary to carry cargos which would become solid if cooled, flexible inserts “Removable coating Tankerpacks” (6) equipped with an integrated cargo heating system (13) (see FIG. 7) are used, wherein the system is connected to the corresponding onboard heat transfer system (14).

When liquid cargo unloading is finished, the tanker does not leave the port berth, whereas flexible inserts (6) are promptly removed from the cargo tanks (4), and the temporary cargo system is disassembled and purged.

As a result, both cargo tanks (4) and pipelines of the onboard cargo system remain clean and thus the tanker is immediately ready for loading next cargo using the onboard cargo system or again using the temporary cargo system and flexible inserts “Removable coating Tankerpacks” (6), if it is also not forbidden to load the next cargo by filling through the upper cargo hatches (9) of the cargo tanks (4).

Therefore, as a result of using the temporary cargo system for liquid cargo transshipment in combination with the flexible inserts “Removable coating Tankerpacks”, the time for cargo turnover is significantly shortened, since the preparation of a tanker for the next loading does not require the tanker to go out to sea, wherein the costs of washing the cargo tanks and the onboard cargo system are significantly reduced, and the cargo tanks and the onboard cargo system are only used in cases where the transshipment of cargo through the upper cargo hatches of cargo tanks is not allowed.

Furthermore, using the claimed method, environment pollution is reduced, since using the temporary cargo system does not require large amounts of detergents, and the time required for washing the portable hoses is minimal and is no more than 12 hours, which is much shorter than the time required for washing the onboard cargo system, which includes not only cargo lines, but also the cargo tanks per se, while the tanker, after unloading the cargo, need not be taken from the berth to the sea for cleaning and it is almost immediately ready for loading next cargo.

1. A method of transshipping liquid cargo in cargo tanks of a tanker, the method comprising loading and unloading of the liquid cargo,
wherein the loading of the liquid cargo comprises:
arranging flexible inserts in the cargo tanks, the flexible inserts having inlet openings and outlet openings provided in an upper part thereof, and being attached at corresponding openings of upper cargo hatches of the cargo tanks, and unfolding the flexible inserts in the cargo tanks;
assembling a temporary cargo system comprising components that include a main deck pipeline to which adapters and portable hoses with shut-off valves are connected, and lowering the portable hoses into the inlet openings of the flexible inserts arranged inside the cargo tanks;
filling the liquid cargo through the upper cargo hatches of the cargo tanks into the flexible inserts so as to load the liquid cargo into the cargo tanks;
disassembling the temporary cargo system after the loading of the liquid cargo; and
wherein the unloading of the liquid cargo comprises:
assembling the temporary cargo system including the main deck pipeline to which adapters and portable hoses with shut-off valves are connected, and submersible pumps attached to ends of the portable hoses;
lowering the portable hoses with the submersible pumps attached thereto into the flexible inserts through the upper cargo hatches of the cargo tanks;
pumping the liquid cargo from the flexible inserts to intended reservoirs at a port using the submersible pumps so as to unload the liquid cargo from the cargo tanks;
disassembling the temporary cargo system after the unloading of the liquid cargo; and
removing the flexible inserts from the cargo tanks and sending the flexible inserts for disposal at the port of unloading.

2. The method of claim 1, wherein when a flexible insert is unfolded, the flexible insert has a shape and size that correspond to those of a cargo tank, and a shape, size, and arrangement of the inlet and outlet openings that correspond to the openings of an upper cargo tank hatch provided with flanges.

3. The method of claim 2, wherein the flexible insert is made of a plastic suitable for use with the liquid cargo to be transported.

4. The method of claim 2, wherein the flexible insert comprises flanges with openings configured to attach to fastening elements provided in corresponding flanges of the openings of an upper cargo hatch.

5. The method of claim 2, wherein the flexible insert is provided with an integrated cargo heating system.

6. The method of claim 5, wherein the integrated cargo heating system is a flexible tube integrated in the flexible insert, the flexible tube configured to be connected to an onboard heat transfer system.

7. The method of claim 1, wherein the flexible inserts are unfolded in the cargo tanks manually and/or using portable onboard fans.

8. The method of claim 1, wherein the temporary cargo system is assembled concurrently with the flexible inserts being arranged in the cargo tanks and attached at the corresponding openings of upper cargo hatches, and the flexible inserts being unfolded in the cargo tanks.

9. The method of claim 1, further comprising:
purging one or more of the components of the temporary cargo system after disassembling the temporary cargo system, after the loading of the liquid cargo or after the unloading of the liquid cargo; and
placing the components of the temporary cargo system in designated storage areas.

10. The method of claim 1, further comprising transporting the tanker to the port before the unloading of the liquid cargo.
